(19) United States
(12) Patent Application Publication
(10) Pub. No.: US 2006/0156304 A1
(43) Pub. Date: Jul. 13, 2006

(54) Apparatus and method for scheduling tasks in a communications network

(76) Inventors: Francois Bourzeix, Ornex (CH); Ralf Hekmann, Chicago, IL (US)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 10/513,646

(22) PCT Filed: Apr. 2, 2003
(86) PCT No.: PCT/EP03/03437

§ 371 Date: Jul. 29, 2005

(30) Foreign Application Priority Data
Apr. 26, 2002 (GB) 0209682.4

(51) Int. Cl. G06F 9/46

(52) U.S. Cl. 718/102

(57) ABSTRACT

A time trigger for instruction execution can be contained within the instruction itself. A time stamp value associated with each of a sequence of instructions, which are written into a FIFO memory (9) by an application specific controller (1), is compared with the output value of a counter (11). When the two values are equal, a comparator 10 sends a command to an instruction decoder (8) to execute the current instruction. The invention has the advantage of a reduced interrupt overhead and his particular application to HiperLAN 2 systems in which it can be incorporated without affecting the protocol handling.

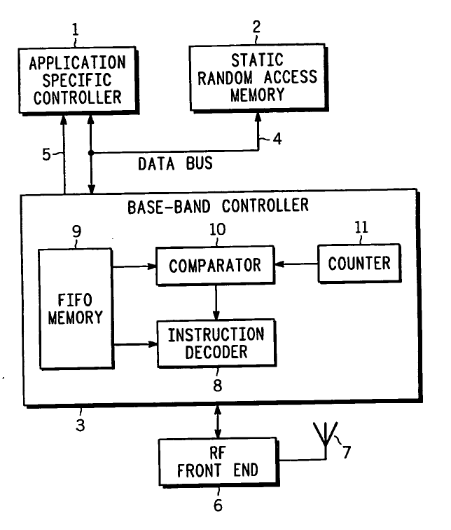

This invention relates to the scheduling of processing tasks in a communications network and has particular application to wireless local area networks (WLAN).

Emerging broad band communication techniques (WLAN eg HiperLAN 2 or IEEE 802.11 systems) are fundamentally changing the way that scheduling of base-band processing in wireless communication devices is handled compared with the more established communications systems such as GSM (global system for mobile communications).

In the GSM system, bit stream processing is performed in a digital signal processor (DSP). Packets of 150 bits (1 time slot) are transmitted during 577 microseconds every 4.6 milliseconds (for 8 time slots) on a regular basis, at a rate of 270 kHz. The DSP runs at a rate of between 13 MHz and 100 MHz.

In contrast, in a HiperLAN 2 broadband system, packets of between 100 and 200 bits (1 traffic channel) are transmitted during periods varying from 8 to 72 microseconds at a rate of 20 MHz and processed on an integrated circuit running at typically 80 MHz. Data transmission is not regular and bandwidth is allocated to transmission when needed.

IEEE 802.11a systems have characteristics similar to HiperLAN 2 and notably have an irregular transmission scheme.

HiperLAN 2 systems need to process data packets up to 70 times faster than a GSM system with a similar clock rate and packet size. In GSM systems, scheduling of base-band processing tasks is generally performed by means of messages written by a host into a dual port memory that a DSP can read, and by means of interrupts generated on a regular basis by a timer module that activates processing of signals. Due to the regular scheme of data transmission and reception in the GSM time division multiple access frame structure, it is possible to design a simple module based on counters for generating regular interrupts for each processing task. However, for a HiperLAN 2 system such a process would not be optimum for two main reasons. Firstly, the tasks are not performed within a regular frame structure, but instead, each frame structure (of 2 milliseconds) is described at the start of the frame in a dedicated data packet and is independent from one frame to the next. Secondly, the number of interrupts to be generated would increase up to 50 times with the same clock rate. Similarly, IEEE 802.11 is characterised by highly irregular frame structures and a similarly high number of interrupts.

Hence, there is a need for a scheduling system optimised for use in a WLAN system.

According to the present invention, there is provided apparatus for scheduling processing tasks, the apparatus including;

a store for holding instructions relating to a plurality of processing tasks for feeding to an instruction decoder, wherein each instruction has a time stamp value associated therewith,

a counter for producing a sequence of counter output values,

and a comparator for monitoring said time stamp and counter output values and for generating a command for sending to the instruction decoder to commence execution of an instruction depending upon the monitored values.

According to a further aspect of the invention, there is provided a method for scheduling processing tasks in accordance with appended claim 5.

Hence, a time trigger for instruction execution can be contained within the instruction itself. This can result In memory saving particularly in cases where relatively small numbers of trigger events are required. A further advantage is a reduced interrupt overhead which can result in simpler programming structures.

In one example, the comparator generates the command when the time stamp value associated with the current instruction is equal to the current counter output value.

Alternatively, certain instructions having a particular time stamp value associated therewith and so-identified by the comparator, are executed immediately.

The store may be configured as a first-in-first-out (FIFO) register wherein instructions are sequenced one after the other.

By incorporating such scheduling apparatus in a WLAN base-band processing arrangement, the base-band processing of data can be scheduled without loading the associated applications specific controller (ASC) with real time tasks such as interrupt generation. In particular, the invention can be incorporated in a HiperLAN 2 system without affecting the protocol handling.

The invention obviates the need for any use of interrupts from the ASC to a base-band processor or for the use of an external module responsible for generating interrupts. As a result, the ASC programming is simplified as it does not have to deal with real time signalling. Further, the base-band processor does not have to manage interrupt contentions and priorities.

Some embodiments of the invention will now be described, by way of example, with reference to the drawing which is a block diagram of components included in a wireless local area network and incorporating scheduling apparatus in accordance with the invention.

In the Figure, an application specific controller (ASC) 1 communicates with an associated static random access memory (SRAM) 2 and with a base-band controller 3 over a data bus 4. An interrupt line 5 also connects the ASC 1 with the base-band controller 3. The base-band controller 3 is also connected to a radio frequency front end 6 which receives and transmits radio frequency (RF) signals via an antenna 7. The components of the Figure as described so far are typical constituents of a HiperLAN 2 system as is an instruction decoder 8, incorporated in the base-band controller 3.

The Figure further shows components in accordance with the preferred embodiment, namely, an instruction first-in-first-out (FIFO) memory 9, a comparator 10 connected thereto and a counter 11 also connected to the comparator 10. The FIFO memory 9 has a further output which is connected to the instruction decoder 8.

In operation, instructions stored In the FIFO memory 9 are fed therefrom to the instruction decoder 8 for execution, their time of execution being controlled by the comparator 10. In order to schedule the base-band controller 3 without overwhelming the ASC 1 with interrupt management, a set of time stamped instructions is defined. The ASC 1 writes in advance a list of instructions, that are to be executed, into the FIFO memory 9. The FIFO's first instruction is executed when the time stamp field of the first instruction equals the value of the counter output as compared by the comparator 10. Instructions typically consist of a code field, a parameter field and a time stamp field. The code is used to differentiate various instructions, the parameter field Is used to characterise instruction processing according to base-band controller specific characteristics and the time stamp field is used to specify execution time. Instructions are unconditional and are executed one after the other (ie no branching). The scheduling apparatus comprising the FIFO memory 9, comparator 10 and counter II is only aware of the current instruction. This instruction is updated once execution has commenced so that the presence of a current pending instruction blocks any other instruction scheduling (ie the ASC 1 writes instructions into the FIFO memory 9 in the order they need to be executed).

An example of an instruction set for use in a HiperLAN 2 system is listed below. Each instruction from 1 to 8 has a time stamp value associated with it (eg instruction 2 has time stamp value T1).

1. Initialise counter (and allow it to run), when counter value=T0

2. Transmit a preamble when counter value=T1.

3. Receive a preamble when counter value=T2.

4a. Transmit N data packets as soon as possible.

4b. Receive N data packets as soon as possible.

5. Measure power when counter value=T3.

6. Send interrupt to ASC when counter value=T4.

7. Wait (for a further instruction) when counter value=T5.

8. Send settings to RF front end when counter value=T6.

An example of an instruction set for use in a system operating in accordance with the IEEE 802.11 standard is listed below.

1. Initialise counter (and allow it to run), when counter value=T0.

2. Transmit a preamble when counter value=T1.

3. Receive a frame (preamble and data packet) when counter value=T2.

4a. Transmit a frame fragment (data packet) as soon as possible.

5. Measure power when counter value=T3.

6. Send interrupt to ASC when counter value=T4.

7. Wait (for a further instruction) when counter value=T5.

8. Send settings to RF front end when counter value=T6.

The instructions 1-8 listed in both the above examples are performed by the instruction decoder 8 on receipt of a command from the comparator 10. The comparator 10 continually monitors the counter output and in the cases of instructions 1-3 and 5-8, generates a command when the counter output value equals the time stamp value of the associated instruction. In the case of instructions 4a and 4b, these are assigned particular, pre-defined time stamp values which trigger the comparator into generating a command for Immediate execution for the instruction without making a comparison with the counter value. At the end of the sequence of instructions 1 to 6, the ASC can be sent an Interrupt signal so that it can perform some other task or wake up from a quiescent state. Instruction 7 defines a period in the instruction decoder has no tasks to perform.

1. Apparatus for scheduling processing tasks, the apparatus including:
a store that is configured as a first-in-first-out memory for holding instructions relating to a plurality of processing tasks for feeding to an instruction decoder, wherein each instruction has a time stamp value associated therewith,
a counter for producing a sequence of counter output values,
and a comparator for monitoring said time stamp and counter output values and for generating a command for sending to the instruction decoder to commence execution of an instruction depending upon the monitored values.

2. Apparatus according to claim 1 wherein the comparator generates the command when the time stamp value of a current instruction equals a current counter output value.

3. Apparatus according to claim 1 wherein the comparator generates a command for immediate execution of an instruction which has a pre-defined time stamp value associated therewith.

4. (canceled)

5. A method for scheduling processing tasks, the method including the steps of: assigning a time stamp value to each of a plurality of processing task instructions, writing said instructions into a memory, monitoring the assigned time stamp value of each instruction and a counter output value, and generating a command for execution of an instruction depending upon the monitored values.

6. A method according to claim 5 wherein the monitoring step comprises comparing the time stamp value with the counter output value and wherein the command is generated when the compared values are equal.

7. A method according to claim 5 wherein the monitoring step comprises identifying an instruction having a pre-defined time stamp value and wherein the command is generated for immediate execution of the so-identified instruction.

8. (canceled)
